(19) United States
(12) Patent Application Publication
(10) Pub. No.: US 2007/0242232 A1
(43) Pub. Date: Oct. 18, 2007

(54) ELECTRONIC DEVICE AND GUIDING DEVICE

(75) Inventors: Fu Shiung Shih, Taichung County (TW); Hsin Hung Li, Taoyuan County (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/734,713

(22) Filed: Apr. 12, 2007

(30) Foreign Application Priority Data
Apr. 14, 2006 (TW) TW95113320

(51) Int. Cl. G03B 21/16

(52) U.S. Cl. 353/61

(57) ABSTRACT

An electronic device comprises a body having a side portion, a first heat source disposed in the body, a first heat dissipation unit generating a first initial airflow to substantially pass through the first heat source, a second heat source generating a second initial airflow to pass through the second heat source and to move toward the side portion of the body, a second heat dissipation unit, and a guiding element disposed on the path of the first and second initial airflows. The first and second initial airflows traveling through the guiding element is respectively converted into a first predetermined airflow and a second predetermined airflow. The first and second predetermined airflows are expelled by the second heat dissipation unit through the side portion of the body.

### BACKGROUND OF THE INVENTION

1. Field of the Invention

The invention relates to a projector, and in particular to a small-size, high power, increased life and side-airflow discharging projector.

2. Description of the Related Art

Projectors typically comprise front, back or side vents. Exhaust from the front-outlet ventilating projector affects the quality of the projected image. The rear-outlet ventilating projectors expel heat to the rear area, thus causing discomfort to the viewers when contacting the heated exhaust. Further, problems such as light leakage formed by the projector are harmful to the eyes.

The side-outlet ventilating projector comprises a heat dissipation system to blow airflow on a lamp of an image device, and the direction of the airflow traveling through the lamp is parallel to the direction of airflow passing through a vent. If the directions of the airflows are changed, pressure loss is relatively increased and the heat dissipation fan is easily burned out. Further, the light path of the Digital Light Processor (DLP) of side-outlet ventilating projectors must be perpendicular to the direction of the vent, thus the volume of the side-outlet ventilating projector cannot be arbitrarily altered or reduced.

### BRIEF SUMMARY OF THE INVENTION

The invention provides an electronic device to prevent a hub of a fan from overheating, to increase the life of the fan, and to reduce volume of the electronic device.

The invention provides a guiding device to guide a first initial airflow and a second initial airflow to dissipate heat. The guiding device comprises a guiding element and a fan. The guiding element comprises a housing, a first guiding zone disposed in the housing, and a second guiding zone disposed outside of the housing. The first initial airflow is guided by the first guiding zone to form the first predetermined airflow, and the second initial airflow is guided by the second guiding zone to form the second predetermined airflow, and the first initial airflow and the second initial airflow enter the housing being perpendicular with each other, and the first and second predetermined airflows flow out of the housing being parallel with each other.

The housing comprises an inlet region connected to the first guiding zone and an outlet region connected to the first guiding zone. The fan comprises a non-central region and a central region disposed in the non-central region, and the first predetermined airflow and the second predetermined airflow travel through the non-central region.

An electronic device of the invention comprises a body having a side portion, a first heat source disposed in the body, a first heat dissipation unit generating a first initial airflow to substantially pass through the first heat source, a second heat source generating a second initial airflow to substantially pass through the second heat source and to move toward the side portion of the body, a second heat dissipation unit, and a guiding element disposed on the path of the first and second initial airflows. The first and second initial airflows traveling through the guiding element is respectively converted into a first predetermined airflow and a second predetermined airflow. The first and second predetermined airflows are substantially driven by the second heat dissipation unit to move toward the side portion of the body and expelled to the exterior of the body.

The first initial airflow is perpendicular to the second initial airflow. The second heat dissipation -unit comprises a non-central region and a central region disposed in the non-central region, and the first predetermined airflow and the second predetermined airflow travel through the non-central region. The second heat dissipation unit comprises a fan having a hub contained in the central region and a plurality of blades contained in the non-central region.

The guiding element comprises a dividing part separating the first heat source from the second heat source. The guiding element comprises a housing, a first guiding zone disposed in the housing, and a second guiding zone disposed outside of the housing. The first initial airflow is guided by the first guiding zone to form the first predetermined airflow, and the second initial airflow is guided by the second guiding zone to form the second predetermined airflow.

The electronic device further comprises an image unit having a reflector, a lens connected to the reflector and disposed at the leading portion and a first heat source. The reflector passing through the inlet region is partially enclosed by the housing.

The first initial airflow traveling through the guiding element is separated by the guiding element to form a first predetermined airflow, and the first predetermined airflow travels toward the side portion.

The electronic device further comprises a first circuit unit having a second source. The first circuit unit can be a ballast unit.

The electronic device further comprises a second circuit unit and a third heat dissipation unit. The third heat dissipation unit generates a third initial airflow traveling through the power board and moving toward the side portion, and the first predetermined airflow passes through the third heat dissipation unit. The second circuit unit can be a power board.

The invention further provides a projector, comprising a body, an image unit, a first heat dissipation unit, a ballast unit, a second heat dissipation unit and a guiding element. The body comprises a leading portion and a side portion disposed next to the leading portion. The image unit comprises a reflector, a lens connected to the reflector and disposed at the leading portion, and a first heat source. The first heat dissipation unit generates a first initial airflow traveling through the first heat source. The ballast unit comprises a second source. The second heat dissipation unit generates a second initial airflow traveling through the second heat source and to move toward the side portion. The guiding element is disposed on paths of the first initial airflow and the second initial airflow. The first initial airflow and the second initial airflow are separated by the guiding element to form a first predetermined airflow and a second predetermined airflow, and the first predetermined airflow and the second predetermined airflow are driven by the second heat dissipation unit and expelled through the side portion.

The first initial airflow is perpendicular to the second initial airflow. The second heat dissipation unit comprises a non-central region and a central region disposed in the non-central region, and the first predetermined airflow and the second predetermined airflow travel through the non-central region. The second heat dissipation unit comprises a fan having a hub contained in the central region and a plurality of blades contained in the non-central region

The guiding element comprises a dividing part separating the first heat source from the second heat source. The guiding element further comprises a housing, a first guiding zone disposed in the housing, and a second guiding zone disposed outside of the housing, wherein the first initial airflow is guided by the first guiding zone to form the first predetermined airflow, and the second initial airflow is guided by the second guiding zone to form the second predetermined airflow.

The projector further comprises a power board and a third heat dissipation unit. The third heat dissipation unit generates a third initial airflow traveling through the power board and moving toward the side portion, and the first predetermined airflow passes through the third heat dissipation unit.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1A is a top view of an electronic device (E1) of a first embodiment of the invention;

FIG. 1B is a schematic view of the distribution of airflows of the electronic device (E1) of the invention;

FIG. 2A is a perspective view of a guiding device (W) of the electronic device (E1) of FIG. 1A;

FIG. 2B is a top view of an electronic device (E1) of the guiding device (W) of FIG. 2A; and

FIG. 3 is a top view of an electronic device (E2) of a second embodiment of the invention.

### DETAILED DESCRIPTION OF THE INVENTION

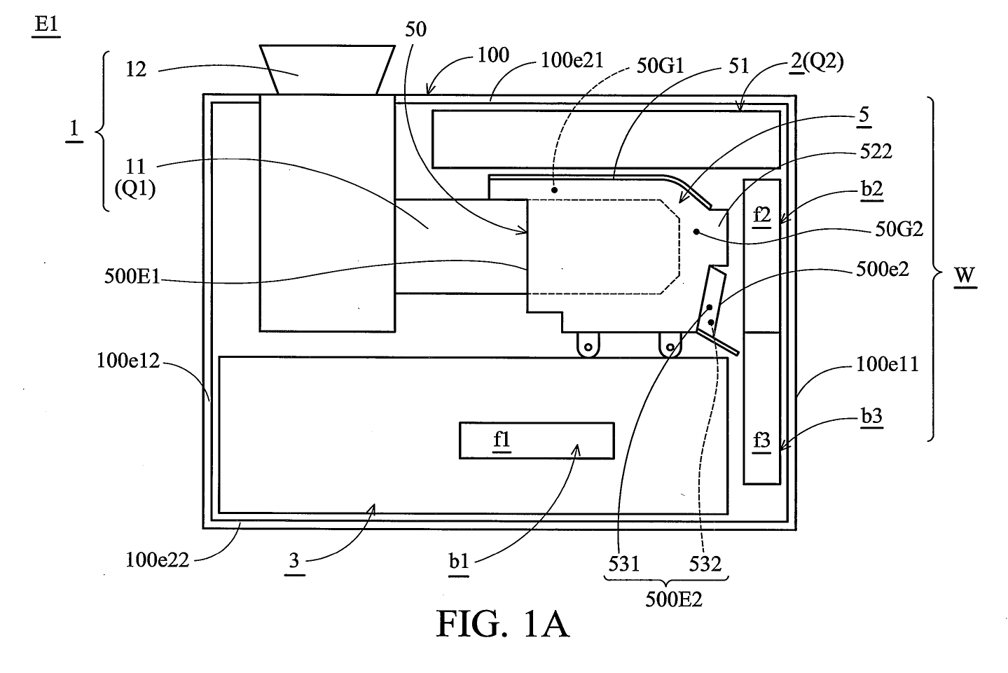

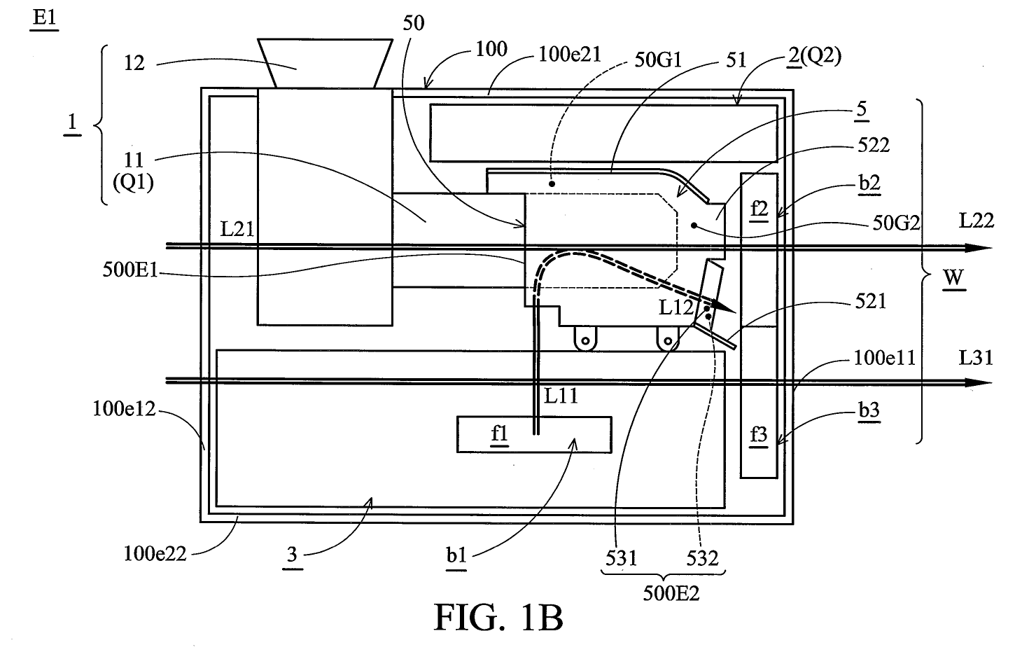

FIG. 1A is a top view of an electronic device E1 of a first embodiment of the invention, and FIG. 1B shows the distribution of airflows of the electronic device E1.

The electronic device E1 comprises a body 100, an image unit 1, a first heat dissipation unit b1, a first circuit unit 2, a second heat dissipation unit b2 having a fan f2, a second circuit unit 3, a third heat dissipation unit b3 having a fan f3, and a guiding element 5. The guiding element 5, the fan f2 of the second heat dissipation unit b2 and the fan f3 of the third heat dissipation unit b3 form a guiding device W, to dissipate the heated airflows from the interior of the body 100. In this embodiment, the electronic device E1 is a projector, and the first circuit unit 2 is a ballast unit of the projector, and the second circuit unit 3 is a power board of the projector.

The image unit 1, the first heat dissipation unit b1, the first circuit unit 2, the second heat dissipation unit b2, the second circuit unit 3, the third heat dissipation unit b3 and the guiding element 5 are received in the body 100. The body 100 is a rectangular hollow case, comprising a leading portion 100e21, a rear portion 100e22 corresponding to the leading portion 100e21, and two side portions 100e11 and 100e12 disposed next to the leading and rear portions 100e21 and 100e22.

The image unit 1 comprises a reflector 11, a lens 12 connected to the reflector 11 and disposed at the leading portion 100e21, and a first heat source Q1 (e.g. a lamp, but not shown in FIGS.). The lens 12 projects the light reflected from the reflector 11 to form an image in front of the leading portion 100e21 of the body 100.

The first heat dissipation unit b1 disposed next to the reflector 11 comprises a fan f1 to generate a first initial airflow L11 traveling through the first heat source Q1 and to dissipate heat from the first heat source Q1.

The image unit 1 is triggered by the first circuit unit 2, electrically connected and disposed next to the image unit 1 and the leading portion 100e21. The first circuit unit 2 comprises a second source Q2, e.g. circuit boards.

The second heat dissipation unit b2 is disposed next to the first circuit unit 2, the guiding element 5 and the side portion 100e11 of the body 100. The fan f2 of the second heat dissipation umit b2 generates a second initial airflow L21 traveling through the second heat source Q2 and moving toward the side portion 100e11 of the body 100, to dissipate heat from the second heat source Q2. The first initial airflow L11 is perpendicular to the second initial airflow L21.

The guiding element 5 is disposed on paths of the first and second initial airflow L11 and L21, and the second initial airflow L21 is guided by the guiding element 5 to form a second predetermined airflow L22. The first and second predetermined airflows L12 and L22 are driven by the second heat dissipation unit b2 and expelled from the body 100 through the side portion 100e11.

The second circuit unit 3 disposed next to the guiding element 5 and the rear portion 100e22 of the body 100 provides electricity to the image unit 1, the first circuit unit 2, the first heat dissipation unit b1, the second heat dissipation unit b2 and the third heat dissipation unit b3.

The fan f3 of the third heat dissipation unit b3 disposed next to the second circuit unit 3, the guiding element 5 and the side portion 100e11 of the body 100 generates a third initial airflow L31 traveling through the second circuit unit 3 and moving toward the side portion 100e11, to dissipate heat from the first circuit unit 2. The first predetermined airflow L12 partially travels through the fan f3 of the third heat dissipation unit b3. In this embodiment, the fan f1 of the first heat dissipation unit b1, the fan f2 of the second heat dissipation unit b2 and the fan f3 of the third heat dissipation unit b3 have the same structure.

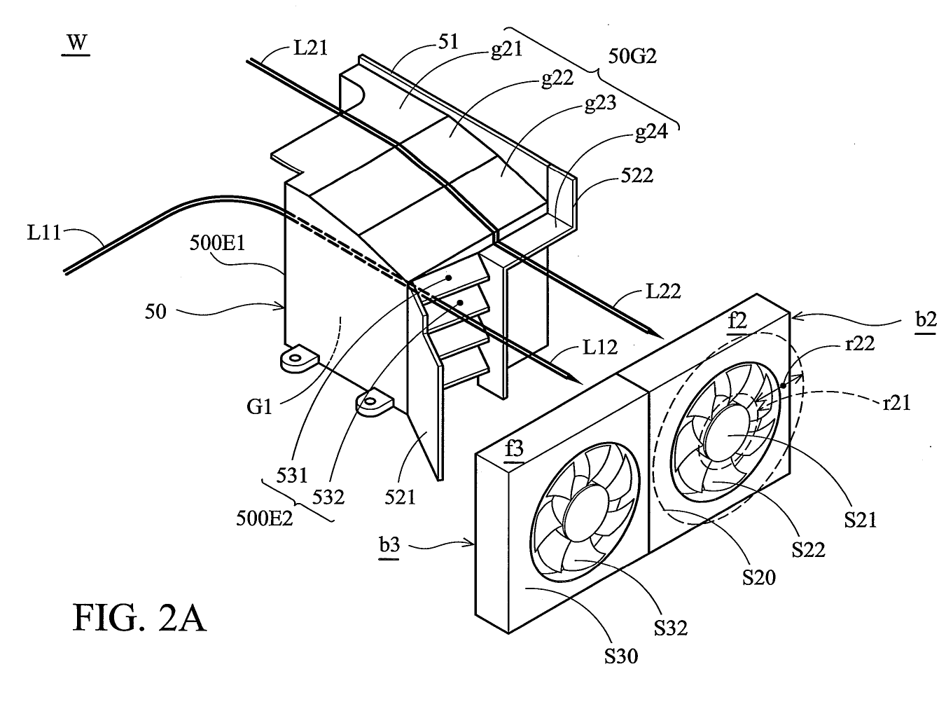

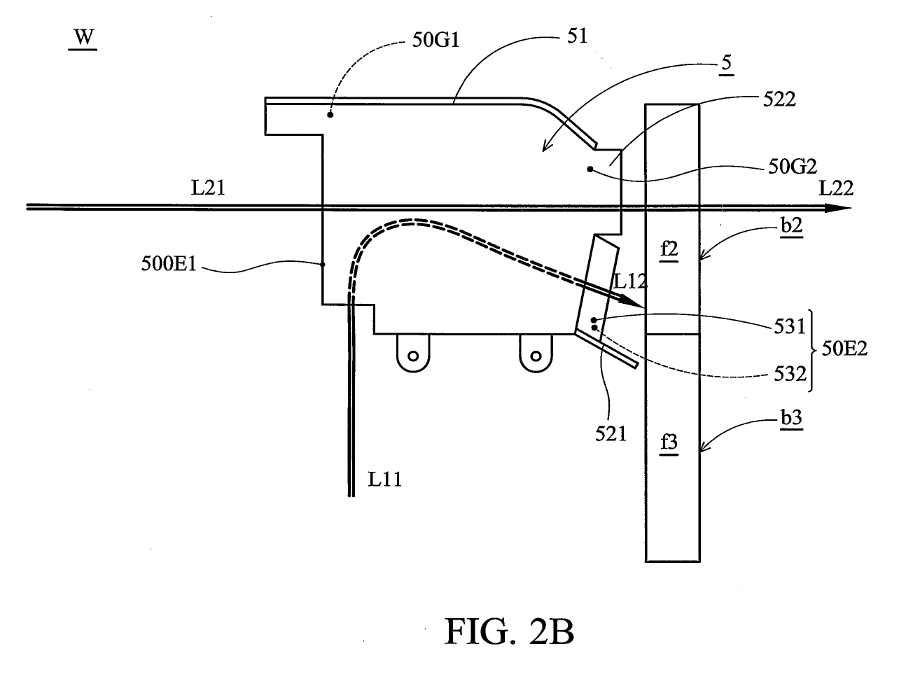

FIG. 2A is a perspective view of a guiding device W of the electronic device E1, and FIG. 2B is a top view of an electronic device E1 of the guiding device W. The guiding element 5 comprises a housing 50, a first guiding zone 50G1 disposed in the housing 50, a dividing part 51, a second guiding zone 50G2 disposed outside of the housing 50, a straight first block plate 521 and an L-shaped second block plate 522.

The housing 50 comprises an inlet region 500E1 connected to the first guiding zone 50G1 and an outlet region 500E2 connected to the first guiding zone 50G1. The reflector 11 passing through the inlet region 500E1 is partially enclosed by housing 50. The outlet region 500E2 of the housing 50 facing the side portion 100e11 of the body 100 comprises a plurality of spaced plates 531 and a plurality of openings 532. The adjustable plates 531 control the direction of the airflows, and the first and second block plates 521 and 522 are disposed at two sides of the outlet region 500E2.

The dividing part 51 located at one sidewall of the housing 50 separating the first heat source Q1 of the image unit 1 from the second heat source Q2 of the first circuit unit 2. The first guiding zone 50G1 connected to the inlet and outlet regions 500E1 and 500E2 is a surface formed on the inside of the housing 50. The second guiding zone 50G2 comprising a plurality of surfaces g21, g22, g23 and g24 is a gradient surface formed on the outside of the housing 50. Note that the surface g21 of the second guiding zone 50G2 is formed on one side of the second block plate 522. That is to say, the first initial airflow L11 is guided by the first guiding zone 50G1 to form the first predetermined airflow L12, and the second initial airflow L21 is guided by the surfaces g21, g22, g23 and g24 of the second guiding zone 50G2 to form the second predetermined airflow L22.

Note that the streamlined profile of the first and second guiding zones 50G1 and 50G2 of the housing 50 is designed by the outer shape of the reflector 11, to facilitate flow rate of the airflow and efficiency of heat dissipation.

The fan f2 of the second heat dissipation unit b2, for example, comprises a frame s20, a hub s21 and a plurality of blades s22; meanwhile, the structure of the fan f2 is divided into two regions, a central region r21 and a non-central region r22. The central region r21 disposed in the non-central region r22 substantially comprises hub s21, and the non-central region r22 substantially comprises the frame s20 and the blades s22.

When the first predetermined airflow L12 is formed by the first guiding zone 50G2, the first predetermined airflow L12 concentrated by the first guiding zone 50G1, the outlet region 500E2 of the housing 50 and the first block plate 521 passes through the non-central regions r22 of the fan f2 of the second heat dissipation unit b2 and the fan f3 of the third heat dissipation unit b3, i.e., the concentrated first predetermined airflow L12 passes through the frame s20 and the blades s22 of the fan f2 and the frame s30 and the blades s32 of the fan f3. When the second predetermined airflow L22 is formed by the second guiding zone 50G2, the second predetermined airflow L22 concentrated by the second guiding zone 50G2 and the second block plate 522 passes through the non-central region r22 of the fan f2 of the second heat dissipation unit b2, i.e., the concentrated second predetermined airflow L22 passes through the frame s20 and the blades s22 of the fan f2.

Thus, the first heat source Q1 of the image unit 1 transmitted by the fan f1 of the first heat dissipation unit b1 does not directly impact on the first circuit unit 2, and the first predetermined airflow L12 generated by the fan f1 of the first heat dissipation unit b1 flows in the same direction as the second predetermined airflow L22. The dissipated heat expelled by the fan f2 of the second heat dissipation unit b2 is transmitted to the exterior through the side portion 100e11 of the body 100, and the first and second predetermined airflows L12 and L22 do not directly impact on the central region r21, i.e., the hub s21 of the fan f2, to prevent the hub s21 of the fan f2 from overheating, to increase the life of the fan f2, and to obtain a reduced volume of the electronic device E1 according to the described arrangement.

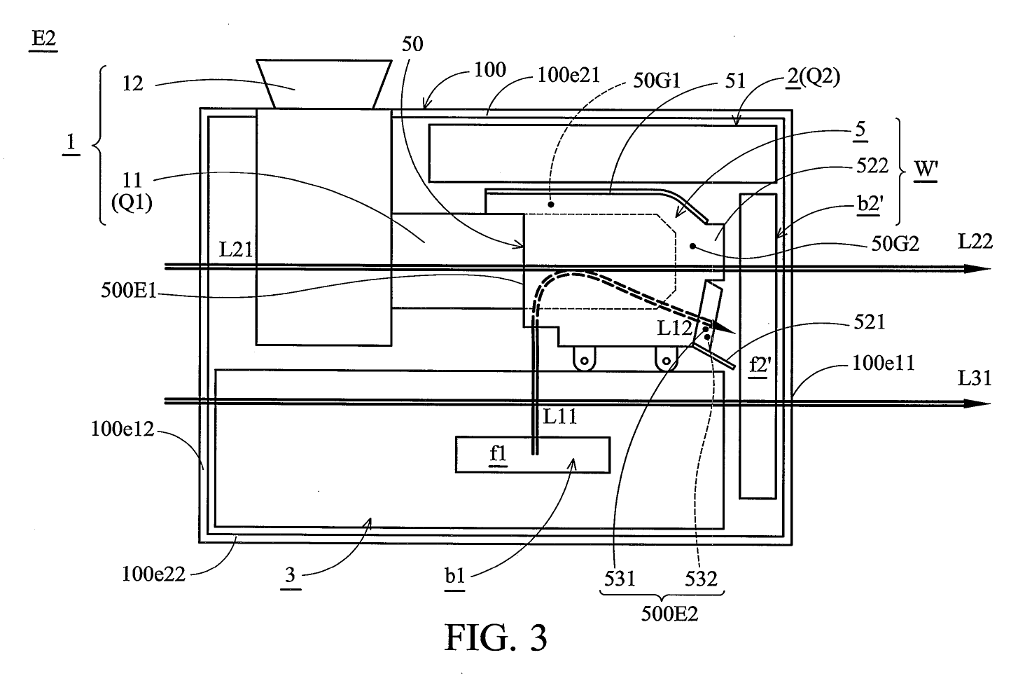

In FIG. 3, an electronic device E2 of the second embodiment of the invention differs from the electronic device E1 in that a guiding device W′ comprises a second heat dissipation unit b2′ having a fan f2′ and the guiding element 5, and the first and second predetermined airflows L12 and L22 are simultaneously guided by the fan f2′ of the second heat dissipation unit b2′ and expelled from the body 100.

The following description is of the best-contemplated mode of carrying out the invention. This description is made for the purpose of illustrating the general principles of the invention and should not be taken in a limiting sense. The scope of the invention is best determined by reference to the appended claims.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device for guiding a first initial airflow, the electronic device comprising:
a body, comprising a side portion;
a first heat source disposed in the body, wherein the first initial airflow passes through the first heat source; and
a guiding element used for guiding the first initial airflow, wherein the first initial airflow traveling through the guiding element is separated by the guiding element to form a first predetermined airflow, and the first predetermined airflow travels toward the side portion.

2. The electronic device as claimed in claim 1 further comprising a first heat dissipation unit to generate the first initial airflow.

3. The electronic device as claimed in claim 1 further comprising a second source and a second heat dissipation unit, wherein the second heat dissipation unit generates a second initial airflow traveling through the second heat source and moving toward the side portion.

4. The electronic device as claimed in claim 3, wherein the guiding element is disposed on paths of the first initial airflow and the second initial airflow, and the second initial airflow is guided by the guiding element to form a second predetermined airflow, and the first predetermined airflow and the second predetermined airflow are driven by the second heat dissipation unit and expelled through the side portion.

5. The electronic device as claimed in claim 1, wherein the first initial airflow is perpendicular to the second initial airflow.

6. The electronic device as claimed in claim 1, wherein the second heat dissipation unit comprises a non-central region and a central region disposed in the non-central region, and the first predetermined airflow and the second predetermined airflow travel through the non-central region.

7. The electronic device as claimed in claim 3, wherein the guiding element comprises a dividing part separating the first heat source from the second heat source.

8. The electronic device as claimed in claim 4, wherein the guiding element comprises a housing, a first guiding zone disposed in the housing, and a second guiding zone disposed outside of the housing, wherein the first initial airflow is guided by the first guiding zone to form the first predetermined airflow, and the second initial airflow is guided by the second guiding zone to form the second predetermined airflow.

9. A projector, comprising:
a body, comprising a leading portion and a side portion disposed next to the leading portion;
an image unit, comprising a reflector, a lens connected to the reflector and disposed at the leading portion, and a first heat source;
a first heat dissipation unit, generating a first initial airflow traveling through the first heat source;
a ballast unit, comprising a second source;
a second heat dissipation unit, generating a second initial airflow traveling through the second heat source and to move toward the side portion; and
a guiding element disposed on paths of the first initial airflow and the second initial airflow, wherein the first initial airflow and the second initial airflow are separated by the guiding element to form a first predetermined airflow and a second predetermined airflow, and the first predetermined airflow and the second predetermined airflow are driven by the second heat dissipation unit and expelled through the side portion.

10. The projector as claimed in claim 9, wherein the first initial airflow is perpendicular to the second initial airflow.

11. The projector as claimed in claim 9, wherein the second heat dissipation unit comprises a non-central region and a central region disposed in the non-central region, and the first predetermined airflow and the second predetermined airflow travel through the non-central region.

12. The projector as claimed in claim 11, wherein the second heat dissipation unit comprises a fan having a hub contained in the central region and a plurality of blades contained in the non-central region.

13. The projector as claimed in claim 9, wherein the guiding element comprises a dividing part separating the first heat source from the second heat source.

14. The projector as claimed in claim 9, wherein the guiding element comprises a housing, a first guiding zone disposed in the housing, and a second guiding zone disposed outside of the housing, wherein the first initial airflow is guided by the first guiding zone to form the first predetermined airflow, and the second initial airflow is guided by the second guiding zone to form the second predetermined airflow.

15. The projector as claimed in claim 9 further comprising a power board and a third heat dissipation unit, wherein the third heat dissipation unit generates a third initial airflow traveling through the power board and moving toward the side portion, and the first predetermined airflow passes through the third heat dissipation unit.

16. A guiding device for guiding a first initial airflow and a second initial airflow, the guiding device comprising:
a guiding element comprises a housing, a first guiding zone disposed in the housing, and a second guiding zone disposed outside of the housing, wherein the first initial airflow is guided by the first guiding zone to form the first predetermined airflow, and the second initial airflow is guided by the second guiding zone to form the second predetermined airflow, and the first initial airflow and the second initial airflow enter the housing being perpendicular with each other, and the first predetermined airflow and the second predetermined airflow flow out of the housing being parallel with each other.

17. The guiding device as claimed in claim 16, wherein the housing comprises an inlet region connected to the first guiding zone and an outlet region connected to the first guiding zone.

18. The guiding device as claimed in claim 16 further comprising a fan to guide the first predetermined airflow and the second predetermined airflow, wherein the fan comprises a non-central region and a central region disposed in the non-central region, and the first predetermined airflow and the second predetermined airflow travel through the non-central region.
